(19) United States
(12) Patent Application Publication
(10) Pub. No.: US 2022/0263460 A1
(43) Pub. Date: Aug. 18, 2022

(54) Solar Power Junction Box Assembly

(71) Applicant: Armando Jimenez, Stockton, CA (US)

(72) Inventor: Armando Jimenez, Stockton, CA (US)

(21) Appl. No.: 17/178,462

(22) Filed: Feb. 18, 2021

(51) Int. Cl. H02S 40/34; H01L 31/02; H01R 9/24

(52) U.S. Cl. CPC H02S 40/34; H01R 9/2416; H01L 31/02013

(57) ABSTRACT

A solar power junction box assembly includes a junction box that is comprised of an electrically insulating material to house a plurality of electrical connections from a solar power generating system. The junction box has a plurality of attachment points each being integrated therein to facilitate the junction box to be integrated into standardized framing spacing in the construction industry. A terminal block is positioned within the junction box to electrically couple to electrical conductors for completing a circuit between respective electrical conductors. A cover is removably attachable to the junction box for closing the junction box and the cover is comprised of an electrically insulating material.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to junction box devices and more particularly pertains to a new junction box device for integrating electrical wiring for solar generated power into a building.

### (2) Description of Related Art including information disclosed under 37 CFR 1.97 and 1.98

The prior art relates to junction box devices including a variety of plastic electrical junction boxes. Additionally, the prior art discloses a variety of electrical junction boxes that have mounting tabs for mounting to construction panels. The prior art discloses an electrical junction box that includes engagements for armored electrical cable. The prior art further discloses an electrical junction box for solar power systems that includes circuitry for processing electrical signal from the solar power system.

### BRIEF SUMMARY OF THE INVENTION

An embodiment of the disclosure meets the needs presented above by generally comprising a junction box that is comprised of an electrically insulating material to house a plurality of electrical connections from a solar power generating system. The junction box has a plurality of attachment points each being integrated therein to facilitate the junction box to be integrated into standardized framing spacing in the construction industry. A terminal block is positioned within the junction box to electrically couple to electrical conductors for completing a circuit between respective electrical conductors. A cover is removably attachable to the junction box for closing the junction box and the cover is comprised of an electrically insulating material.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a solar power junction box assembly according to an embodiment of the disclosure.

FIG. 2 is a perspective cut-away view of an embodiment of the disclosure.

FIG. 3 is a phantom in-use view of an embodiment of the disclosure.

FIG. 4 is a perspective in-use view of an embodiment of the disclosure.

### DETAILED DESCRIPTION OF THE INVENTION

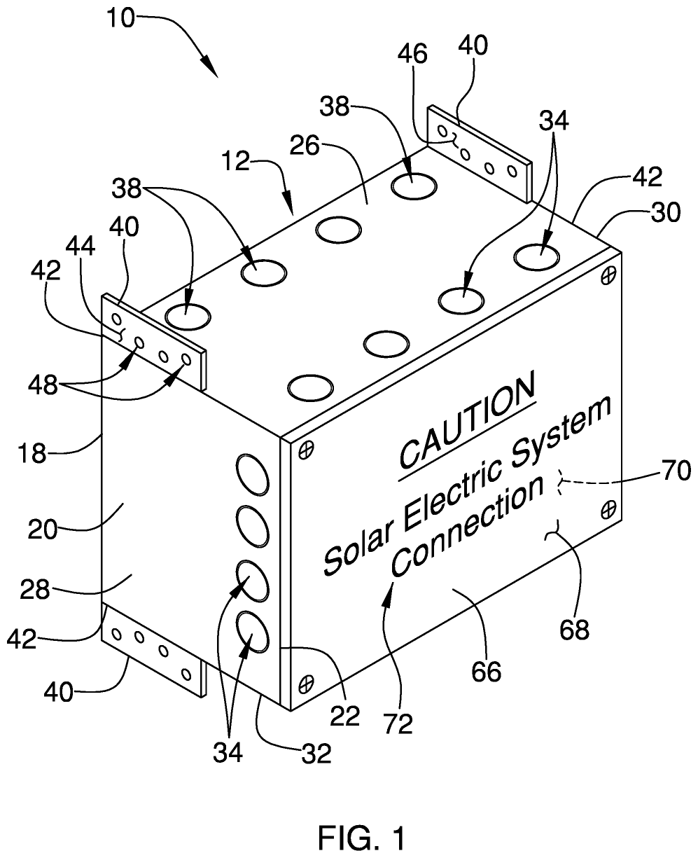

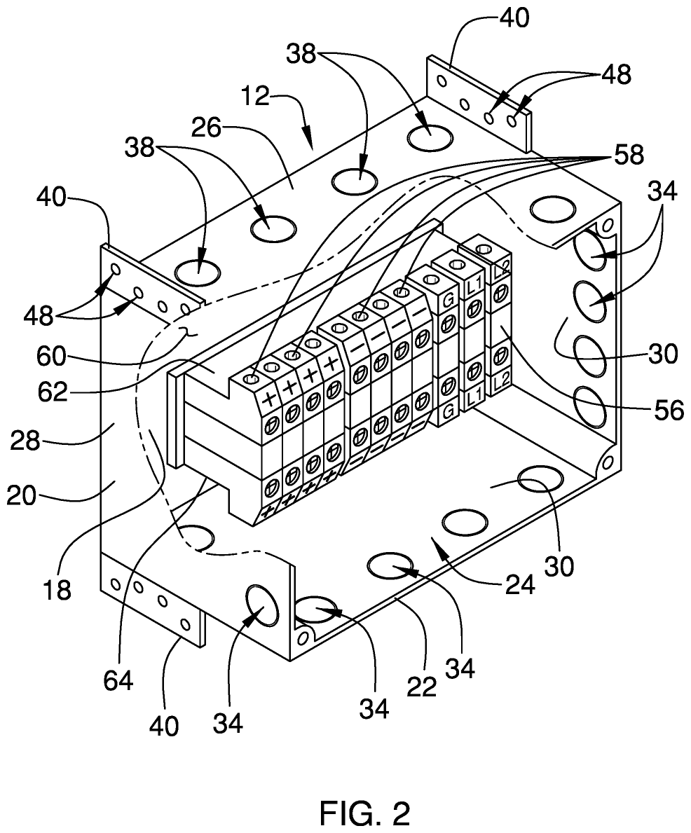

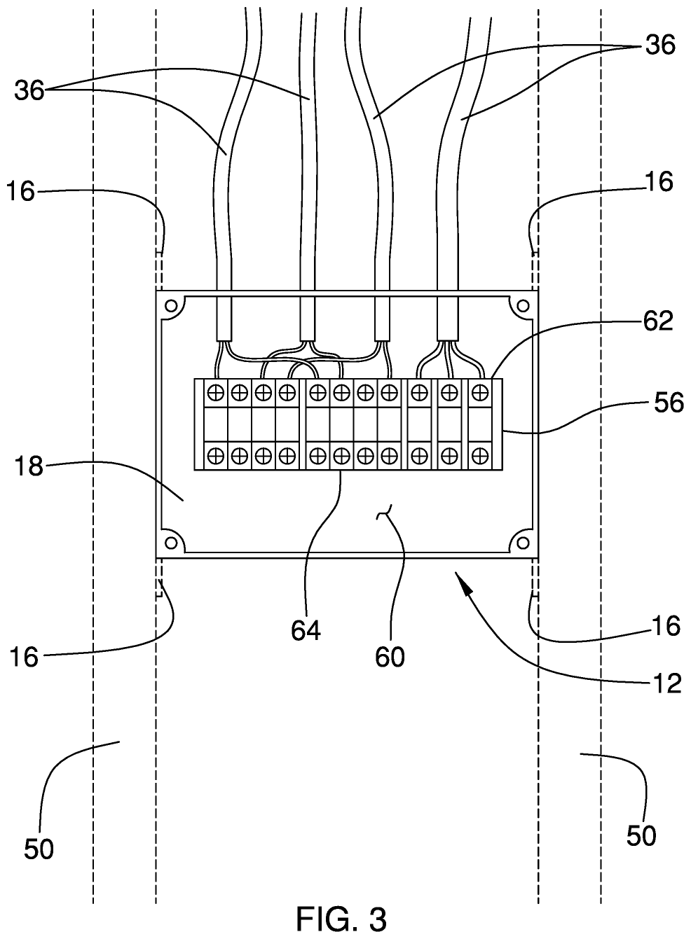

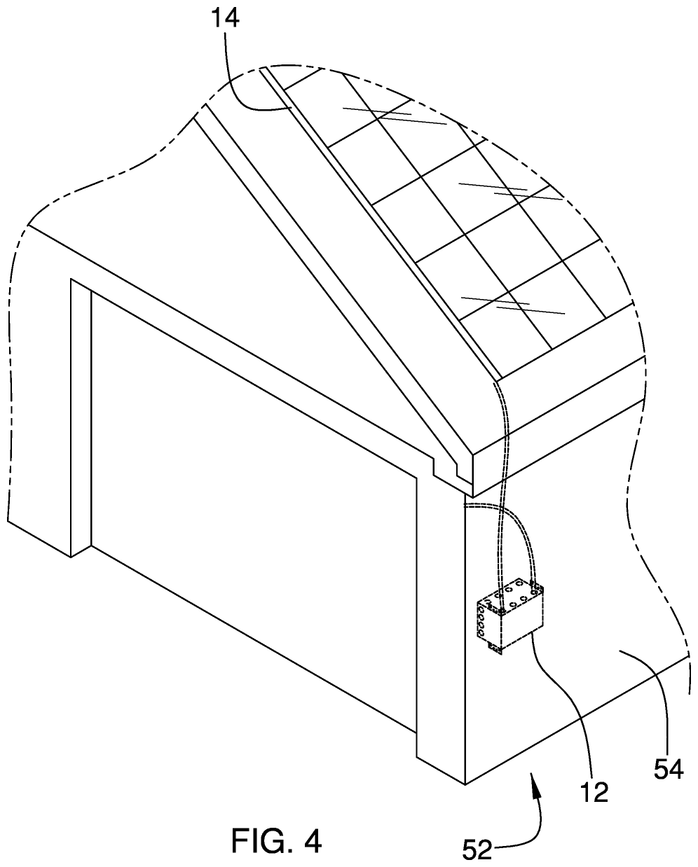

With reference now to the drawings, and in particular to FIGS. 1 through 4 thereof, a new junction box device embodying the principles and concepts of an embodiment of the disclosure and generally designated by the reference numeral 10 will be described.

As best illustrated in FIGS. 1 through 4, the solar power junction box assembly 10 generally comprises a junction box 12 that is comprised of an electrically insulating material, such as plastic or the like, to house a plurality of electrical connections from a solar power generating system 14. The junction box 12 has a plurality of attachment points 16 each being integrated therein. The attachment points 16 are spaced apart from each other a pre-determined distance to facilitate the junction box 12 to be integrated into standardized framing spacing in the construction industry. The junction box 12 has a back wall 18 and an outer wall 20 extending forwardly therefrom, and the outer wall 20 has a distal edge 22 with respect to the back wall 18 to define an opening 24 into an interior of the junction box 12. The outer wall 20 has a top side 26, a first lateral side 28, a second lateral side 30 and a bottom side 32.

The outer wall 20 has a plurality of first holes 34 each extending therethrough to accommodate an electrical conductor 36 extending into the junction box 12. The first holes 34 are spaced apart from each other and are distributed around the top side 26, the bottom side 32, the first lateral side 28 and the second lateral side 30 of the outer wall 20. Additionally, each of the first holes 34 is positioned adjacent to the distal edge 22 of the outer wall 20. The outer wall 20 has a plurality of second holes 38 each extending therethrough to accommodate an electrical conductor 36 extending into the junction box 12. The second holes 38 are spaced apart from each other and are distributed along the top side 26 and the bottom side 32 of the outer wall 20. Each of the second holes 38 is positioned adjacent to the back wall 18.

A plurality of tabs 40 is each coupled to and extends away from the outer wall 20 of the junction box 12. Each of the tabs 40 is aligned with respective ones of four corners 42 of the outer wall 20 such that each of the tabs 40 defines a respective one of the attachment points 16. Each of the tabs 40 is oriented to extend along a line extending between the back wall 18 and the distal edge 22 of the outer wall 20. Each of the tabs 40 has a first surface 44 and a second surface 46, and each of the tabs 40 has a plurality of apertures 48 each extending through the first surface 44 and the second surface 46. Moreover, each of the apertures 48 in each of the tabs 40 can accommodate a fastener to engage framing 50 in a building 52 for mounting the junction box 12 in a wall 54 of the building 52. Each of the tabs 40 extends from the back wall 18 toward the distal edge 22 such that each of the second holes 38 is positioned in the wall 54 and each of the first holes 34 is exposed with respect to the wall 54.

A terminal block 56 is positioned within the junction box 12 and the terminal block 56 has a plurality of connection points 58 each being integrated therein. In this way each of the connection points 58 can be electrically coupled to a respective electrical conductor 36 for completing a circuit between respective electrical conductors 36. The terminal block 56 may be an electrical terminal block of any conventional design that conforms to the National Electrical Code for residential electrical construction. The terminal block 56 is mounted to an inside surface 60 of the back wall 18 of the junction box 12, and the terminal block 56 extends between the first lateral side 28 and the second lateral side 30 of the outer wall 20.

The terminal block 56 has an upper side 62 and a lower side 64, and each of the connection points 58 is integrated into a respective one of the upper side 62 and the lower side 64. Each of the connection points 58 on the upper side 62 is in electrical communication with a respective one of the connection points 58 on the lower side 64. Moreover, the connection points 58 are spaced apart from each other and are distributed along a full length of the terminal block 56.

A cover 66 is removably attachable to the junction box 12 for closing the junction box 12. The cover 66 is comprised of an electrically insulating material such as plastic or the like. The cover 66 has a front surface 68 and a back surface 70, and the back surface 70 abuts the distal edge 22 of the outer wall 20 of the junction box 12 when the cover 66 closes the junction box 12. The front surface 68 has indicia 72 printed thereon and the indicia 72 comprise the words “caution” and “solar electric system connection”.

In use, the junction box 12 is integrated into the wall 54 during construction of the building 52 that will employ a solar power generation system 14. In this way the electrical wiring associated with the solar power generation system 14 can be routed into the junction box 12. Thus, the electrical wiring can be electrically coupled to appropriate connection points 58 on the terminal block 56. The junction box 12 conforms to requirements of solar power generation systems 14 with regard to local, state and federal regulations thereby ensuring a smooth installation and inspection process with respect to solar power generation equipment.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A solar power junction box assembly for containing power connections from a solar power generation system, said assembly comprising:
a junction box being comprised of an electrically insulating material wherein said junction box is configured to house a plurality of electrical connections from a solar power generating system, said junction box having a plurality of attachment points each being integrated therein, said attachment points being spaced apart from each other a pre-determined distance wherein said attachment points are configured to facilitate said junction box to be integrated into standardized framing spacing in the construction industry;
a terminal block being positioned within said junction box, said terminal block having a plurality of connection points each being integrated therein wherein each of said connection points is configured to be electrically coupled to a respective electrical conductor for completing a circuit between respective electrical conductors; and
a cover being removably attachable to said junction box for closing said junction box, said cover being comprised of an electrically insulating material.

2. The assembly according to claim 1, wherein:
said junction box has a back wall and an outer wall extending forwardly therefrom, said outer wall having a distal edge with respect to said back wall to define an opening into an interior of said junction box, said outer wall having a top side, a first lateral side, a second lateral side and a bottom side;
said outer wall has a plurality of first holes each extending therethrough wherein each of said first holes is configured to accommodate an electrical conductor extending into said junction box, said plurality of first holes being spaced apart from each other and being distributed around said top side, said bottom side, said first lateral side and said second lateral side of said outer wall, each of said first holes being positioned adjacent to said distal edge of said outer wall; and
said outer wall has a plurality of second holes each extending therethrough wherein each of said second holes is configured to accommodate an electrical conductor extending into said junction box, said second holes being spaced apart from each other and being distributed along said top side and said bottom side of said outer wall, each of said second holes being positioned adjacent to said back wall.

3. The assembly according to claim 2, further comprising a plurality of tabs, each of said tabs being coupled to and extending away from said outer wall of said junction box, each of said tabs being aligned with respective ones of four corners of said outer wall such that each of said tabs defines a respective one of said attachment points, each of said tabs being oriented to extend along a line extending between said back wall and said distal edge of said outer wall.

4. The assembly according to claim 3, wherein each of said tabs has a first surface and a second surface, each of said tabs having a plurality of apertures each extending through said first surface and said second surface wherein each of said apertures in each of said tabs is configured to accommodate a fastener to engage framing in a building for mounting said junction box in a wall of the building.

5. The assembly according to claim 3, wherein each of said tabs extends from said back wall toward said distal edge wherein each of said second holes is configured to be positioned in the wall and each of said first holes is configured to be exposed with respect to the wall.

6. The assembly according to claim 2, wherein said terminal block is mounted to an inside surface of said back wall of said junction box, said terminal block extending between said first lateral side and said second lateral side of said outer wall, said terminal block having an upper side and a lower side, each of said connection points being integrated into a respective one of said upper side and said lower side, each of said connection points on said upper side being in electrical communication with a respective one of said connection points on said lower side, said connection points being spaced apart from each other and being distributed along a full length of said terminal block.

7. The assembly according to claim 2, wherein said cover has a front surface and a back surface, said back surface abutting said distal edge of said outer wall of said junction box when said cover closes said junction box, said front surface having indicia being printed thereon, said indicia comprising the words “caution” and “solar electric system connection”.

8. A solar power junction box assembly for containing power connections from a solar power generation system, said assembly comprising:
a junction box being comprised of an electrically insulating material wherein said junction box is configured to house a plurality of electrical connections from a solar power generating system, said junction box having a plurality of attachment points each being integrated therein, said attachment points being spaced apart from each other a pre-determined distance wherein said attachment points are configured to facilitate said junction box to be attached to standardized framing spacing in the construction industry, said junction box having a back wall and an outer wall extending forwardly therefrom, said outer wall having a distal edge with respect to said back wall to define an opening into an interior of said junction box, said outer wall having a top side, a first lateral side, a second lateral side and a bottom side, said outer wall having a plurality of first holes each extending therethrough wherein each of said first holes is configured to accommodate an electrical conductor extending into said junction box, said plurality of first holes being spaced apart from each other and being distributed around said top side, said bottom side, said first lateral side and said second lateral side of said outer wall, each of said first holes being positioned adjacent to said distal edge of said outer wall, said outer wall having a plurality of second holes each extending therethrough wherein each of said second holes is configured to accommodate an electrical conductor extending into said junction box, said second holes being spaced apart from each other and being distributed along said top side and said bottom side of said outer wall, each of said second holes being positioned adjacent to said back wall;
a plurality of tabs, each of said tabs being coupled to and extending away from said outer wall of said junction box, each of said tabs being aligned with respective ones of four corners of said outer wall such that each of said tabs defines a respective one of said attachment points, each of said tabs being oriented to extend along a line extending between said back wall and said distal edge of said outer wall, each of said tabs having a first surface and a second surface, each of said tabs having a plurality of apertures each extending through said first surface and said second surface wherein each of said apertures in each of said tabs is configured to accommodate a fastener to engage framing in a building for mounting said junction box in a wall of the building, each of said tabs extending from said back wall toward said distal edge wherein each of said second holes is configured to be positioned in the wall and each of said first holes is configured to be exposed with respect to the wall;
a terminal block being positioned within said junction box, said terminal block having a plurality of connection points each being integrated therein wherein each of said connection points is configured to be electrically coupled to a respective electrical conductor for completing a circuit between respective electrical conductors, said terminal block being mounted to an inside surface of said back wall of said junction box, said terminal block extending between said first lateral side and said second lateral side of said outer wall, said terminal block having an upper side and a lower side, each of said connection points being integrated into a respective one of said upper side and said lower side, each of said connection points on said upper side being in electrical communication with a respective one of said connection points on said lower side, said connection points being spaced apart from each other and being distributed along a full length of said terminal block; and
a cover being removably attachable to said junction box for closing said junction box, said cover being comprised of an electrically insulating material, said cover having a front surface and a back surface, said back surface abutting said distal edge of said outer wall of said junction box when said cover closes said junction box, said front surface having indicia being printed thereon, said indicia comprising the words “caution” and “solar electric system connection”.
